(19) United States
(12) Patent Application Publication
(10) Pub. No.: US 2015/0037474 A1
(43) Pub. Date: Feb. 5, 2015

(54) Prepared Dough for Baked Goods with Novel Organoleptic Properties

(71) Applicant: Loni Shaw, Crestview, FL (US)

(72) Inventor: Loni Shaw, Crestview, FL (US)

(21) Appl. No.: 13/958,597

(22) Filed: Aug. 4, 2013

(51) Int. Cl. A21D 2/02; A21D 8/00

(52) U.S. Cl. CPC A21D 2/02; A21D 8/00
USPC 426/250; 426/551

(57) ABSTRACT

The present invention discloses a novel method of creating dough for baked goods, particularly cookies, featuring small amounts of flavoring and texturing additive mixed for an extended period of time with other ingredients such that novel organoleptic properties (flavor and texture or “mouthfeel”) are imparted to the baked goods created from the dough.

### CROSS-REFERENCE TO RELATED APPLICATIONS

Not Applicable.

### FIELD OF THE INVENTION

The present invention relates to a novel method of creating dough for baked goods, particularly cookies, featuring small amounts of flavoring and texturing additive mixed for an extended period of time with other ingredients such that novel organoleptic properties (flavor and texture or “mouthfeel”) are imparted to the baked goods created from the dough.

### BACKGROUND OF THE INVENTION

Baked goods are created by blending various “dry” ingredients together with various “wet” ingredients and subjecting the resulting free-flowing, semi-liquid granular mixture to baking heat for a pre-determined time. Typical dry ingredients include, but are not limited to, flour, sugar, and shortening, and other ingredients such as leavening, organoleptic modifiers, and inclusions such as nuts, bits of fruit, candy, and so on. Typical organoleptic modifiers include, but are not limited to, peanut butter, cream cheese, sour cream, and heavy cream. To prepare for baking, the selected dry and wet ingredients are mechanically mixed to form a dough incorporating some fraction of atmospheric air.

Ordinarily, baked goods with added organoleptic modifiers are created with significant amounts of such ingredients because the goal is to have a cookie that exhibits organoleptic properties related to the admixed organoleptic modifier. For example, a sampling of ten peanut butter cookie recipes disclose peanut butter as an ingredient of the dough (minus inclusions) in ratios by volume as high as 40.8% and as low as 13.7%. Similarly, a sampling of ten recipes for sour cream cookies disclose sour cream as an ingredient of the dough (minus inclusions) in ratios by volume as high as 17.1% and as low as 10.1%. While an almost infinite variety of formulations for preparing dough for baked goods are known in the art, formulations featuring reduced amounts of such organoleptic modifiers—less than 10% by pre-mixed volume—are relatively uncommon This is unsurprising: Using conventional preparation techniques, admixed organoleptic modifiers must be present in sufficiently large amounts that consumers can readily perceive them.

However, when prepared in accordance with the teachings of the present invention, it is possible to use greatly reduced amounts of organoleptic modifier—preferably less than 7% by premixed volume—to produce baked goods with readily identifiable, yet delicate and subtle, organoleptic properties presently unknown in baked goods. It is an therefore an object of the present invention to provide a method of admixing reduced amounts of an organoleptic modifier in dough for the purpose of creating baked goods with novel organoleptic properties.

### SUMMARY OF THE INVENTION

The present invention relates to the discovery of a novel means of preparing dough for baked goods, preferably cookies, having an unexpectedly desirable delicate, subtle flavor and pleasant mouthfeel unobtainable in the prior art. The mixes of the present invention are characterized by the presence of a relatively small quantity of an organoleptic modifier. Such organoleptic modifiers are, without limitation: peanut butter, cream cheese, sour cream, and heavy cream. To practice the present invention, a relatively small amount of organoleptic modifier is mixed with sweetener, shortening, egg, and flavoring (if any) at very high speed for an extended period of time—in excess of 7 minutes. This extended, high speed beating denatures the egg protein in the egg, and causes a significant quantity of entrained atmospheric air to become trapped in bubbles in the egg protein slurry.

It is theorized that various organic compounds, particularly fatty acids, present in the organoleptic modifier are liberated by the extended mixing process and become concentrated into the air trapped in bubbles inside the egg protein slurry. The remaining protein and fat molecules present in the organoleptic modifier are evenly deposited throughout the egg protein matrix thus locking these organic compounds inside the bubbles. When baked, the egg protein matrix solidifies and traps these organic compounds inside the protein and fat coated bubbles. When consumed, the resulting baked product exhibits a delicate, subtle flavor with pleasant mouthfeel heretofore unavailable in the prior art. In a generic formulation without added inclusions the various ingredients of the present invention are mixed in the following percentage amounts (by pre-mixed volume) to form dough:

| | Formula | |
|---|---|---|
| Ingredient | % (w/o inclusions) | Formula % (w/ inclusions) |
| Flour | 41.23 | — |
| Sugar(s) | 30.92 | — |
| Shortening | 15.46 | — |
| Egg | 4.51 | — |
| Flavoring | 0.62 | — |
| Leavening Agent | 0.41 | — |
| Organoleptic modifier | 6.85 | — |

### Process:

1. Thoroughly mix sugar(s), shortening, egg solids, flavoring, and organoleptic modifier at high speed—in excess of 200 RPM—to creamy liquid target density (more than 7 minutes).
2. Gently blend in pre-sifted flour with other dry ingredients.

### DETAILED DESCRIPTION OF THE INVENTION

The following is a list of definitions for terms used herein:

“Pre-mixed volume (without inclusions)” or “premixed volume of said dough without inclusions” refers to the total of the dry or wet volumes in the dough minus inclusions, such substances specifically representing: flour, sugar, shortening, egg, flavoring (if any), leavening agent, and organoleptic modifier.

“Formula % (w/o inclusions)” refers to the dry or wet volume of the substance in question divided by the sum of the dry or wet volumes of all substances in the dough minus inclusions, such substances specifically representing: flour, sugar, shortening, egg, flavoring (if any), leavening agent, and organoleptic modifier. This value is expressed as a percentage.

“Formula % (w/ inclusions)” refers to the dry or wet volume of the substance in question divided by the sum of the dry or wet volumes of all substances in the dough. This value is expressed as a percentage.

The dough of the present invention can be packaged in a variety of formats including raw, refrigerated, partially (or “par”) baked, or frozen. When baked as a cookie, the doughs of the present invention provide a cookie with a consistency and mechanical properties reminiscent of “home” or “fresh” baked cookies.

The flour can be soft or hard wheat flour with small portions, up to about 10% by volume, of a high-protein variety and/or starch. A typical flour used in such doughs is soft white “winter” wheat flour with a protein content of about 7.5% to 8.5%. Flours with higher fiber content may be used to prevent or limit cookie spread during baking or to preserve any ornamental imprint applied to the cookie during manufacturing process. The present invention includes flour in amounts ranging up to about 50.00% by pre-mixed volume (without inclusions). The embodiments disclosed contain flour in the range of about 39.91% to about 46.81% by pre-mixed volume (without inclusions).

The sugar can be sucrose or mixtures of sucrose with dextrose or fructose. The sugar can be refined or unrefined containing a residual amount of molasses and/or may contain additional admixed quantities of molasses. The present invention includes sugar in amounts ranging from about 25.00% to about 35.00% by pre-mixed volume (without inclusions). The embodiments disclosed contain sugar in the range of about 28.03% to about 30.92% by pre-mixed volume (without inclusions). Those having skill in the art will recognize that various non-nutritive or reduced-calorie sweeteners may be substituted for at least part of the sugar in the present invention. Such substances are well known in the art and include, but are not limited to: sucralose and acesulfame potassium. Since these substances are far sweeter than sugar, the amount needed to practice the invention is greatly reduced, although preferably at least some sugar will be retained to give more conventional texturing characteristics to the finished product.

The shortening, or fat, can be solid, semi-solid, or liquid or any mixture thereof at room temperature. These shortening materials may be of any type including animal or plant derived including, for example, beef lard or tallow, butter, butter oil, canola oil, coconut oil, copra oil, corn oil, cotton oil, margarine, olive oil, palm oil, palm kernel oil, peanut oil, safflower oil, soybean oil, sunflower oil, or any combination thereof. The shortening can be emulsified or stabilized using a variety of suitable stabilizers known in the art, including but not limited to monoglycerides or diglycerides. The present invention includes shortening in amounts varying from about 10.00% to about 20.00% by pre-mixed volume (without inclusions). The embodiments disclosed contain shortening in the range of about 14.02% to about 15.46% by pre-mixed volume (without inclusions).

The dough of the present invention contains egg or egg products including, for example, whole eggs, egg whites, egg substitute, or reconstituted (hydrated) egg-solid. The present invention includes egg or egg products in amounts ranging from about 3.00% to about 6.00% by pre-mixed volume (without inclusions). The embodiments disclosed contain egg or egg products in the range of about 4.09% to about 4.51% by pre-mixed volume (without inclusions).

The dough of the present invention may contain flavoring agents including for example, cinnamon, cocoa powder, fruit flavoring, ginger, lemon, orange, mango, vanilla, and the like or any combination of these. Ordinarily, however, these flavorings will be present in smaller quantities so as not to interfere with the delicate taste imparted to the baked goods when manufactured in accordance with the teachings of the present invention. The present invention includes flavoring agents in amounts ranging up to about 1.00% by pre-mixed volume (without inclusions). The embodiments disclosed contain flavoring agents up to about 0.62% by pre-mixed volume (without inclusions).

The dough of the present invention contains a leavening agent to provide acceptable rising and flow properties during the baking process to ensure the production of a baked product of the desired size and shape. The leavening agent can be any of the conventional ones used in the preparation of baked goods including for example, sodium bicarbonate or various phosphate compounds such as disodium dihydrogen pyrophosphate or sodium aluminum phosphate. Ordinary baking powder, comprising generally a bicarbonate or carbonate salt, some acidifying agent such as a low molecular weight organic acid like lactic acid, and a separating agent such as starch may also be used. The present invention includes leavening agents in amounts ranging up to about 1.00% by pre-mixed volume (without inclusions). The embodiments disclosed contain leavening agents in the range of about 0.37% to about 0.41% by pre-mixed volume (without inclusions).

The dough of the present invention contains an organoleptic modifier. Such substances include, but are not limited to, peanut butter, cream cheese, sour cream, and heavy cream. These organoleptic modifiers are present in quantities far below those found in conventional baked goods: The present invention includes these substances in amounts ranging up to 7.00% by pre-mixed volume (minus inclusions). The embodiments disclosed contain organoleptic modifier in the range of about 6.21% to about 6.85% by pre-mixed volume (without inclusions).

The dough of the present invention may contain inclusions as are well known in the art. Examples include caramel, chocolate pieces, fruit pieces, oat flakes, raisins, whole nuts or nut pieces (such as almonds, peanuts, pecans, walnuts, and the like), or combinations thereof. These inclusions may be of any suitable size and in any suitable amount.

The dough of the present invention may contain coloring agents as are well known in the art. The present invention includes coloring agents in amounts ranging up to about 0.10% by pre-mixed volume (without inclusions). The embodiments disclosed contain up to about 0.02% by pre-mixed volume (without inclusions).

The dough of the present invention may be prepared using any conventional dough handling or mixing and handling process. However, in all embodiments of the present invention, all the ingredients except the flour, leavening agent, and any inclusions are pre-mixed at high speed—above 200 RPM—for a period of time not less than 7 minutes. This extending mixing serves to denature the protein present in the egg such that the ordinarily tightly coiled chains of protein are elongated and are deposited on the surface of numerous bubbles of air that are formed in the slurry. The longer the slurry is mixed, the more aerated it becomes, the bubbles become smaller, and the slurry increases in volume. Simultaneously, various organic compounds present in the organoleptic modifier are mechanically liberated from the organoleptic modifier as a vapor and become trapped in the air bubbles.

After preparation, the dough of the present invention may be provided in any physical form, including without limitation: 1) Individual decoratively shaped or imprinted pieces formed by impression in a die; 2) Individual decoratively shaped pieces formed by extrusion and wire cutting; 3) A brick; and, 4) A sausage-like log. Similarly, the dough of the present invention may be supplied in any physical form, including without limitation, refrigerated or frozen forms.

The present invention takes advantage of recent research indicating that human beings can perceive various fatty acid compounds by sense of smell. For example, in several embodiments of the present invention using peanut butter as an organoleptic modifier, linoleic acid (C₁₈H₃₂O₂), oleic acid (C₁₈H₃₄O₂), palmitic acid (C₁₆H₃₂O₂), and other fatty acids are released from the peanut butter as a vapor during high-speed mixing. These vapors become concentrated and trapped in the air bubbles that form in the sugar-shortening-egg slurry as it is beaten. After mixing for the appropriate amount of time, the remaining ingredients are then gently blended into the slurry so as to not disturb the bubbles and the vapor concentrated inside them. It is theorized that extended beating of the slurry is required to raise the concentration of vapor-phase linoleic and other fatty acids to a sufficient level that at least some of the linoleic and other fatty acids remain as a vapor as the baked product cools. This is a crucial step in practicing the present invention, because it has recently been discovered that human beings can detect vapor-phase linoleic and other fatty acids. Bryson Bolton & Bruce Halpern, Orthonasal and Retronasal but not Oral-Cavity-Only Discrimination of Vapor-Phase Fatty Acids, 35 Chem. Senses, 229 (2010). While there is no evidence that oral cavity detection via the trigeminal nerve is possible, it is clear that vapor phase fatty acids are orthonasally and/or retronasally detectable. As a result, baked goods made using the teachings of the present invention take advantage of this recently discovered human psycho-sensory ability to deliver a delicate and subtle flavor profile unavailable in the prior art.

A sensory panel evaluated test cookies made in accordance with Examples 8, 9, and 11 of the present invention. These chocolate, vanilla nut, and orange sorbet cookies, respectively, were compared with control cookies made using the same ingredients differing from the recipes of the present invention only in that the mixing time used to combine the flour, sugar, shortening (butter), egg, leavening agent (baking powder), and organoleptic modifier was limited to 3 minutes versus a minimum of 7 minutes as practiced by the present invention. The panel was asked to evaluate the aroma of the cookies using a provided list of suggested descriptive terms including: fragrant (as in a mix of flavors), rich, decadent, creamy, delicate, fresh, light, bland, unbalanced (with one ingredient predominating), powdery/nutty, and unpleasant. The panel was asked to evaluate the texture or “mouthfeel” of the cookies using a provided list of suggested descriptive terms including: velvety, savory, creamy, whipped, melt-in-the-mouth, smooth, soft, hard, crunchy, granular and rough.

Generally, in all three cases, over 90% of all members of the panel were able to qualitatively differentiate the test cookies and the control cookies. Also, in all three cases, slightly more than 10% of the panel members preferred the control cookie over the test cookie.

In the case of the chocolate cookie, the terms used most to describe the texture of test cookie were: 1) Whipped; 2) Velvety; and, 3) Savory. The terms used most to describe the control cookie were: 1) Crunchy and 2) Granular. In the case of the vanilla nut cookie, the terms used most to describe the texture of the test cookie were: 1) Whipped; 2) Smooth; and, 3) Melt-in-the-mouth. The terms used most to describe the control cookie were: 1) Hard and 2) Crunchy. In the case of the orange sorbet cookie, the terms used most to describe the texture of the test cookie were: 1) Whipped; 2) Smooth; and, 3) Soft. The terms used most to describe the control cookie were: 1) Hard; and, 2) Crunchy.

In the case of the chocolate cookie, the terms used most to describe the aroma of the test cookie were: 1) Fragrant (as in a mix of flavors); 2) Rich, and, 3) Decadent. In the case of the vanilla nut cookie, the terms used most to describe the aroma of the test cookie were: 1) Powdery/nutty; 2) Milky; and, 3) Creamy. In the case of the orange sorbet cookie, the terms used most to describe the aroma of the test cookie were: 1) Fragrant (as in a mix of flavors); 2) Delicate; 3) Fresh; and 4) Light. In all three cases the words used most to describe the control cookie were: 1) Bland and 2) Unbalanced (with one ingredient predominating).

The invention will be further described by reference to the following non-limiting preferred embodiments of the present invention:

### Example 1

### Peanut Butter Dough with Novel Organoleptic Properties

| Ingredient | Formula % (w/o inclusions) | Formula % (w/ inclusions) |
|---|---|---|
| Flour | 41.48 | — |
| Sugar | 30.92 | — |
| Butter | 15.46 | — |
| Egg | 4.51 | — |
| Baking Powder | 0.41 | — |
| Peanut Butter | 6.65 | — |

### Process:

1. Thoroughly mix sugar, butter, egg, and peanut butter at high speed—in excess of 200 RPM—to target density (more than 7 minutes).
2. Gently blend in pre-sifted flour and baking powder.

### Example 2

### Chocolate Chip Dough with Novel Organoleptic Properties

| Ingredient | Formula % (w/o inclusions) | Formula % (w/ inclusions) |
|---|---|---|
| Flour | 41.23 | 31.54 |
| Sugar | 30.92 | 23.65 |
| Butter | 15.46 | 11.83 |
| Egg | 4.51 | 3.45 |
| Vanilla Extract | 0.62 | 0.47 |
| Baking Powder | 0.41 | 0.32 |
| Peanut Butter | 6.85 | 5.24 |
| Chocolate | — | 23.65 |
| Chips | | |

### Process:

1. Thoroughly mix sugar, butter, egg, vanilla extract, and peanut butter at high speed—in excess of 200 RPM—to target density (more than 7 minutes).
2. Gently blend in pre-sifted flour and baking powder.
3. Blend in chocolate chips.

### Example 3

### Strawberries and Cream Dough with Novel Organoleptic Properties

| Ingredient | Formula % (w/o inclusions) | Formula % (w/ inclusions) |
|---|---|---|
| Flour | 41.23 | — |
| Sugar | 30.92 | — |
| Butter | 15.46 | — |
| Egg | 4.51 | — |
| Strawberry | 0.62 | — |
| Extract | | |
| Baking Powder | 0.41 | — |
| Cream Cheese | 6.85 | — |

### Process:

1. Thoroughly mix sugar, butter, egg, strawberry extract, and cream cheese at high speed—in excess of 200 RPM—to target density (more than 7 minutes).
2. Gently blend in pre-sifted flour and baking powder.

### Example 4

### White Chocolate Macadamia Nut Dough with Novel Organoleptic Properties

| | Formula | |
|---|---|---|
| Ingredient | % (w/o inclusions) | Formula % (w/ inclusions) |
| Flour | 46.81 | 31.54 |
| Sugar | 28.08 | 20.43 |
| Butter | 14.04 | 10.22 |
| Egg | 4.10 | 2.98 |
| Almond Extract | 0.37 | 0.27 |
| Baking Powder | 0.37 | 0.27 |
| Heavy Cream | 6.23 | 4.53 |
| White Chocolate Chips | — | 13.62 |
| Macadamia Nuts | — | 13.62 |

### Process:

1. Thoroughly mix sugar, butter, egg, almond extract, and heavy cream at high speed—in excess of 200 RPM—to target density (more than 7 minutes).
2. Gently blend in pre-sifted flour, baking powder.
3. Blend in white chocolate chips and macadamia nuts.

### Example 5

### White Chocolate Peanut Dough with Novel Organoleptic Properties

| | Formula | |
|---|---|---|
| Ingredient | % (w/o inclusions) | Formula % (w/ inclusions) |
| Flour | 46.81 | 31.54 |
| Sugar | 28.08 | 20.43 |
| Butter | 14.04 | 10.22 |
| Egg | 4.10 | 2.98 |
| Almond Extract | 0.37 | 0.27 |
| Baking Powder | 0.37 | 0.27 |
| Heavy Cream | 6.23 | 4.53 |
| White Chocolate Chips | — | 13.62 |
| Peanuts | — | 13.62 |

### Process:

1. Thoroughly mix sugar, butter, egg, almond extract, and heavy cream at high speed—in excess of 200 RPM—to target density (more than 7 minutes).
2. Gently blend in pre-sifted flour and baking powder.
3. Blend in white chocolate chips and peanuts.

### Example 6

### Pecan Dream Dough with Novel Organoleptic Properties

| Ingredient | Formula % (w/o inclusions) | Formula % (w/ inclusions) |
|---|---|---|
| Flour | 41.23 | 34.17 |
| Sugar | 25.77 | 21.36 |
| Brown Sugar | 5.15 | 4.27 |
| Butter | 15.46 | 12.82 |
| Egg | 4.51 | 3.74 |
| Caramel | 0.62 | 0.53 |
| Extract | | |
| Baking Powder | 0.41 | 3.4 |
| Peanut Butter | 6.85 | 5.68 |
| Pecans | — | 17.09 |

### Process:

1. Thoroughly mix sugar, butter, egg, caramel extract, and peanut butter at high speed—in excess of 200 RPM—to target density (more than 7 minutes).
2. Gently blend in pre-sifted flour and baking powder.
3. Blend in pecans.

### Example 7

### Sugar Dough with Novel Organoleptic Properties

| Ingredient | Formula % (w/o inclusions) | Formula % (w/ inclusions) |
|---|---|---|
| Flour | 46.81 | — |
| Sugar | 28.08 | — |
| Butter | 14.04 | — |
| Egg | 4.10 | — |
| Vanilla Extract | 0.37 | — |
| Baking Powder | 0.37 | — |
| Heavy Cream | 6.23 | — |

### Process:

1. Thoroughly mix sugar, butter, egg, vanilla extract, and heavy cream at high speed—in excess of 200 RPM—to target density (more than 7 minutes).
2. Gently blend in pre-sifted flour and baking powder.

### Example 8

### Heavenly Chocolate Dough with Novel Organoleptic Properties

| | Formula | |
|---|---|---|
| Ingredient | % (w/o inclusions) | Formula % (w/ inclusions) |
| Flour | 39.91 | 33.27 |
| Sugar | 29.93 | 24.95 |
| Butter | 14.97 | 12.48 |
| Egg | 4.37 | 3.64 |
| Vanilla Extract | 0.60 | 0.50 |
| Baking Powder | 0.40 | 0.33 |
| Peanut Butter | 6.64 | 5.53 |
| White Chocolate Chips | — | 16.64 |
| Baker's Chocolate | — | 2.66 |

### Process:

1. Thoroughly mix sugar, butter, egg, vanilla extract, and peanut butter at high speed—in excess of 200 RPM—to target density (more than 7 minutes).
2. Gently blend in pre-sifted flour and baking powder.
3. Blend in white chocolate chips and baker's chocolate.

### Example 9

### Vanilla Walnut Dough with Novel Organoleptic Properties

| | Formula | |
|---|---|---|
| Ingredient | % (w/o inclusions) | Formula % (w/ inclusions) |
| Flour | 41.23 | 31.49 |
| Sugar | 30.92 | 23.62 |
| Butter | 15.46 | 11.81 |
| Egg | 4.51 | 3.44 |
| French Vanilla Extract | 0.62 | 0.47 |
| Baking Powder | 0.41 | 0.31 |
| Peanut Butter | 6.85 | 5.24 |
| Walnuts | — | 23.62 |

### Process:

1. Thoroughly mix sugar, butter, egg, French vanilla extract, and peanut butter at high speed—in excess of 200 RPM—to target density (more than 7 minutes).
2. Gently blend in pre-sifted flour and baking powder.
3. Blend in walnuts.

### Example 10

### Cinnamon Roll Dough with Novel Organoleptic Properties

| | Formula | |
|---|---|---|
| Ingredient | % (w/o inclusions) | Formula % (w/ inclusions) |
| Flour | 41.23 | 40.23 |
| Sugar | 30.92 | 30.17 |
| Butter | 15.46 | 15.09 |
| Egg | 4.51 | 4.40 |
| Cinnamon Extract | 0.62 | 0.60 |
| Baking Powder | 0.41 | 0.40 |
| Cream Cheese | 6.85 | 6.69 |
| Ground Cinnamon | — | 2.41 |

### Process:

1. Thoroughly mix sugar, butter, egg, cinnamon extract, and cream cheese at high speed—in excess of 200 RPM—to target density (more than 7 minutes).
2. Gently blend in pre-sifted flour and baking powder.
3. Blend in ground cinnamon.

### Example 11

### Orange Sorbet Dough with Novel Organoleptic Properties

| | Formula | |
|---|---|---|
| Ingredient | % (w/o inclusions) | Formula % (w/ inclusions) |
| Flour | 41.23 | — |
| Sugar | 30.92 | — |
| Butter | 15.46 | — |
| Egg | 4.51 | — |
| Orange Extract | 0.62 | — |
| Baking Powder | 0.41 | — |
| Cream Cheese | 6.85 | — |
| Orange Food Coloring | <0.02 | — |

### Process:

1. Thoroughly mix sugar, butter, egg, orange extract, orange food coloring, and cream cheese at high speed—in excess of 200 RPM—to target density (more than 7 minutes).
2. Gently blend in pre-sifted flour and baking powder.

### Example 12

### Oatmeal Raisin Dough with Novel Organoleptic Properties

| Ingredient | Formula % (w/o inclusions) | Formula % (w/ inclusions) |
|---|---|---|
| Flour | 44.11 | 29.60 |
| Sugar | 24.50 | 16.44 |
| Brown Sugar | 4.90 | 3.29 |
| Butter | 14.70 | 9.87 |
| Egg | 4.29 | 2.88 |
| Vanilla Extract | 0.59 | 0.39 |
| Baking Powder | 0.39 | 0.26 |
| Heavy Cream | 6.52 | 4.37 |
| Oats | — | 19.73 |
| Raisins | — | 13.16 |

### Process:

1. Thoroughly mix sugar, brown sugar, butter, egg, vanilla extract, and heavy cream at high speed—in excess of 200 RPM—to target density (more than 7 minutes).
2. Gently blend in pre-sifted flour and baking powder.
3. Blend in oats and raisins.

### Example 13

### Banana Pudding Dough with Novel Organoleptic Properties

| | Formula | |
|---|---|---|
| Ingredient | % (w/o inclusions) | Formula % (w/ inclusions) |
| Flour | 46.72 | — |
| Sugar | 28.03 | — |
| Butter | 14.02 | — |
| Egg | 4.09 | — |
| Banana Extract | 0.56 | — |
| Baking Powder | 0.37 | — |
| Heavy Cream | 6.21 | — |
| Yellow Food Coloring | <0.02 | — |

### Process:

1. Thoroughly mix sugar, butter, egg, banana extract, yellow food coloring, and heavy cream at high speed—in excess of 200 RPM—to target density (more than 7 minutes).
2. Gently blend in pre-sifted flour and baking powder.

What is claimed is:

1. A method of preparing dough for baked goods with novel organoleptic properties, said method comprising the steps of:
a) combining sugar, shortening, egg, and an organoleptic modifier to form a slurry;
b) mixing said slurry with an air entraining rotary mixer at a speed not less than about 200 RPM for a time not less than about 7 minutes;
c) gently mixing pre-sifted flour and leavening agent into said slurry to form a dough for baked goods;
d) wherein said organoleptic modifier comprises a selection of at least one member of the group consisting of:
a. peanut butter;
b. cream cheese;
c. sour cream; and,
d. heavy cream;
e) wherein said organoleptic modifier comprises less than about 7.0% of the total premixed volume of said dough without inclusions.

2. The method of claim 1 wherein said sugar comprises about 25.0% to about 35.0% of the total premixed volume of said dough without inclusions.

3. The method of claim 1 wherein said shortening comprises about 10.00% to about 20.0% of the total premixed volume of said dough without inclusions.

4. The method of claim 1 wherein said egg comprises about 3.00% to about 6.00% of the total premixed volume of said dough without inclusions.

5. The method of claim 1 wherein said pre-sifted flour comprises up to about 50.00% of the total premixed volume of said dough without inclusions.

6. The method of claim 1 wherein said leavening agent comprises up to about 1.00% of the total premixed volume of said dough without inclusions.

7. The method of claim 1 wherein said slurry further comprises coloring agents.

8. The method of claim 1 wherein said slurry further comprises flavoring agents.

9. The method of claim 1 wherein said dough further comprises inclusions.
